(19) United States
(12) Patent Application Publication
(10) Pub. No.: US 2015/0083002 A1
(43) Pub. Date: Mar. 26, 2015

(54) METHOD FOR OPERATING A HYDRAULIC PRESS, AND HYDRAULIC PRESS

(71) Applicants: Matthias Graf, Bretten (DE); Bernd Bodenstein, Eppingen (DE); Manfred Maier, Gemmingen (DE)

(72) Inventors: Matthias Graf, Bretten (DE); Bernd Bodenstein, Eppingen (DE); Manfred Maier, Gemmingen (DE)

(73) Assignee: Dieffenbacher GmbH Maschinen- und Anlagenbau, Eppingen (DE)

(21) Appl. No.: 14/399,822

(22) PCT Filed: May 7, 2013
(86) PCT No.: PCT/EP2013/059544

§ 371 Date: Nov. 7, 2014

(30) Foreign Application Priority Data
May 10, 2012 (DE) 10 2012 104 125.3

(51) Int. Cl. B30B 15/16; F15B 1/033

(52) U.S. Cl. CPC B30B 15/163; F15B 1/033
USPC 100/35; 100/48

(57) ABSTRACT

A hydraulic press and a method for operating the press in cycles. The aim is to lower energy consumption in a hydraulic press for shaping workpieces and a method thereof. Each cycle has at least one phase in which the storage pressure p_{S} in the accumulator presses hydraulic fluid into a chamber of a hydraulic cylinder in order to move a ram relative to the cylinder, the ram being coupled to the cylinder. In at least one portion of each cycle, a hydraulic pump driven by a motor delivers hydraulic fluid to the accumulator at a charging volume flow rate. The storage pressure p_{S} is adjusted to a reference value P_{SOLL} by setting the speed of the motor to a nominal motor speed n_{N} and to at least one intermediate value n_{Z}, where 0<n_{Z}<n_{N}.

The invention relates to a method for operating a hydraulic press according to the preamble of Patent claim 1 and also a hydraulic press according to the preamble of Patent claim 22.

DE 25 44 794 A1 describes a hydraulic press consisting of a press framework, a hydraulic drive, an oil pump, and two accumulators. The hydraulic drive consists of a working cylinder having a working piston of greater diameter and a movement cylinder having a movement piston of lesser diameter. The pistons are fixedly connected to one another with spacing. The working cylinder is fed from the first accumulator via a directional valve and the movement cylinder is fed from the second accumulator via a servo valve inside a closed control loop. The control loop consists of a target value generator, a regulating amplifier, the servo valve, a travel transducer, and a measurement amplifier. The directional valve is implemented as a valve having fixed switch positions. To secure the hydraulic system against excessively high pressures, a pressure limiting valve is arranged in the pressure line of the pump which leads to the accumulators. The quantity of oil required for the drive of the press is delivered by the pump from a tank via the accumulator. A compressible medium from a gas bottle is applied to the accumulator.

This document additionally describes the work sequence and operation of this press, in which the uppermost position of the hydraulic piston is the starting point. After the system is turned on and the accumulators are filled, a signal is given by the target value generator to the regulating amplifier. This actuates the servo valve into the position in which oil is released for feeding the movement cylinder. The movement piston and therefore the working piston connected fixedly thereto move downward. This downward movement is transmitted to the travel transducer. The output signal of the travel transducer is converted in the measuring amplifier into a signal proportional to the travel, which is compared in the regulating amplifier to the target value signal. Deviations of the two signals are processed in the regulating amplifier and provide correction signals to the servo valve. The regulating amplifier, the servo valve, the movement cylinder, the travel transducer, and the measuring amplifier thus form a closed control loop, which enables the movement of the movement piston in proportion to an electrical signal coming from the target value generator. In this manner, the working piston is moved into a precisely established position up to shortly before or on the workpiece.

During the second part of the working stroke, the pressing stroke, which is initiated by switching over the directional valve, the first accumulator, which was previously filled with a quantity of oil metered in accordance with the pressing stroke, is applied to the working piston via the directional valve. This quantity of oil causes a predetermined continuation of the movement of the working piston, which corresponds to the quantity of oil metered in the first accumulator.

After the working piston has carried out the pressing stroke, the directional valve is switched over again and the movement piston moves back into the starting position in the movement cylinder. The oil present in the working cylinder is conveyed back via the directional valve into the tank in this case.

During the working pause, the pump refills the first accumulator with the predetermined quantity of pressure oil, which can be predefined by a limit switch on the first accumulator, which switches an oil valve in the pressure line of the pump leading to the first accumulator.

In this known method and this known press, the filling of the first accumulator to the predetermined quantity of pressure oil is thus regulated during the working pause in that the charging volume stream is set and/or changed by switching the oil valve. Since a compressible medium from the gas bottle is applied to the first accumulator, this filling regulation corresponds to a regulation of the pressure prevailing in the first accumulator to a pressure reference variable, which is dependent on the limit switch and the compressible medium from the gas bottle. In the case of this known regulation, the charging volume stream is set to zero, in that the oil valve is switched into a shutoff position, in which it disconnects the first accumulator from the pressure fitting of the pump. It is disadvantageous in this case that then the pump, which is still driven by the still running motor, increases the pressure in the pressure line until the pressure limiting valve responds and connects the pressure fitting to the tank, so that the pump runs at full speed in idle. This results in an unnecessarily high power consumption. In addition, the pump must be designed sufficiently large that it can deliver the predetermined quantity of pressure oil into the accumulator during the working pause.

It is the object of the invention to reduce the energy consumption in a method for shaping workpieces by means of a hydraulic press and a hydraulic press for shaping workpieces.

This object is achieved by a method according to claim 1 and a press according to claim 22. Further possible embodiments and variants are described in the dependent claims.

According to a first aspect, the invention proposes a method for operating a hydraulic press in cycles, in particular for shaping workpieces, wherein:
each cycle has at least one phase, in which hydraulic fluid is pressed out of a hydraulic accumulator (15) into a chamber (11.1, 11.2) of a hydraulic cylinder (11) of the press (10) by the accumulator pressure p_{S} prevailing in the accumulator (15), in order to move a ram (12) of the press (10), which is coupled to the cylinder (11), and which can be coupled to a shaping tool (21) for shaping a workpiece, in relation to the cylinder (11);
in at least one part of each cycle, a hydraulic pump (13) driven by a motor (14) conveys hydraulic fluid into the accumulator (15) with a charging volume stream and the accumulator pressure p_{S} is regulated to a pressure reference variable P_{SOLL}, in that a speed of the motor (14) is set to a nominal speed n_{N} of the motor (14) and to at least one intermediate value n_{Z}, for which 0<n_{Z}<n_{N} applies.

Since therefore in the case of this proposed method, the setting of the charging volume stream is performed by setting the speed of the motor to the nominal speed n_{N} and to at least one intermediate speed n_{Z} and the energy requirement of the motor, for example, the fuel consumption of an internal combustion engine or the power consumption of an electric motor, is less at speeds below nominal speed n_{N} than at nominal speed n_{N}, the energy consumption can be reduced in comparison to the method known from DE 25 44 794 A1. In this way, the efficiency of the method can also be increased. In addition, a reduction of the speed also results in a noise reduction.

The nominal speed is understood here as the maximum speed which the motor can provide for a longer time without damage, or for which the design of the motor is intended.

The proposed method can be implemented as needed in an arbitrary manner and can have, for example, the regulation of the accumulator pressure p_{S} in at least one additional phase.

The press can be, for example, one of the presses proposed according to the second aspect described hereafter.

The pump can be implemented as needed in an arbitrary manner, for example, as a gearwheel pump, axial piston pump, or radial piston pump.

The motor can be implemented as needed in an arbitrary manner and can be an asynchronous motor, for example, and the setting of its speed can be performed as needed in an arbitrary manner, for example, by means of a frequency converter.

In the closing phase, the moving or positioning or lowering or raising of the ram to the first stroke height is preferably performed proceeding from the third stroke height.

In the working phase, the ram can be kept at the second stroke height as needed after the lowering of the ram, for example, in that the press chamber is closed and/or is disconnected from accumulator and tank.

In the reset phase, the movement or positioning or lowering or raising of the ram to the third stroke height is preferably performed without intermediate step at the first stroke height.

For the pressure reference variable P_{SOLL}, for example, the maximum pressure which the accumulator can withstand for a longer time or for which the design of the accumulator is intended, can simply be selected.

The speed is preferably set continuously to speeds from zero up to the nominal speed n_{N}.

It can be provided that in at least one of the phases, the pressure reference variable P_{SOLL} is set as a function in dependence on at least one chamber pressure p_{K} prevailing in the chambers.

It can then be provided that for the function: P_{SOLL}=p_{K}+K_{P}, wherein K_{P} is a pressure correction value with 0<K.

In this way, it is ensured that the accumulator always provides sufficient overpressure in comparison to the chamber pressure pK, which often rises again and again during the phase, but on the other hand is not excessively high, so that the motor does not have to run unnecessarily rapidly or the pump does not have to deliver unnecessarily strongly.

The pressure correction value K_{P} can be selected arbitrarily as needed and can be constant at least during one part of the phase and/or at least during one part of the other phases, for example. Alternatively or additionally, it can be chronologically variable at least during one part of the phase and/or at least during one part of the other phases, for example. Alternatively or additionally, it can be selected in such a manner, for example, that the pressure reference variable P_{SOLL} is greater by a specific percentage than the chamber pressure pK. This percentage is, for example, at least 2% or at least 3% or at least 4% or at least 5% or at least 6% or at least 7% or at least 8% or at least 9% or at least 10% or at least 12% or at least 14% or at least 16% or at least 18% or at least 20%. Alternatively or additionally, this percentage is, for example, at most 2% or at most 3% or at most 4% or at most 5% or at most 6% or at most 7% or at most 8% or at most 9% or at most 10% or at most 12% or at most 14% or at most 16% or at most 18% or at most 20%.

It can be provided that the regulation of the accumulator pressure p_{S} is performed in at least one of the phases.

It can be provided that
each cycle has a closing phase for closing the press, a working phase for shaping the workpiece, a reset phase for opening the press, and a charging phase for removing a shaped workpiece from the press and for inserting a workpiece to be shaped into the press in this sequence;
in the closing phase, the ram is moved to a first stroke height, so that the shaping tool touches the workpiece to be shaped or is located at a slight spacing to the workpiece to be shaped;
in the working phase, the ram is moved back to a second stroke height, so that the shaping tool presses against the workpiece;
in the reset phase, the ram is moved back to the first stroke height and further to a third stroke height, so that the shaping tool disengages and moves away from the shaped workpiece;
in the charging phase, the ram is kept at the third stroke height.

It can then be provided that in the closing phase, the chamber is disconnected from the accumulator and connected to a tank, or the chamber is disconnected from a tank and is connected to the accumulator.

In the first alternative, the ram can be lowered or moved passively by its intrinsic weight and/or actively by a closing drive in the closing direction or can be raised or moved actively by a closing drive in the closing direction. This closing drive can be, in comparison to a hydraulic drive for the working phase, which is preferably formed by a press chamber in the cylinder and the accumulator, smaller and/or weaker and/or faster, for example, and/or can have an additional hydraulic drive, for example.

In the second alternative, the ram is actively lowered or raised or moved in the closing direction by the accumulator.

It can be provided that in the working phase, the movement of the ram is performed in that a press chamber forming the chamber is disconnected from a tank and connected to the accumulator.

It can then be provided that in the reset phase, the press chamber is disconnected from the accumulator and connected to the tank.

The ram can thus be raised or moved in the reset direction actively by a reset drive or passively by its intrinsic weight and/or can be lowered or moved actively by a reset drive in the reset direction. This reset drive can be, for example, in comparison to a hydraulic drive for the working phase, which is preferably formed by a press chamber in the cylinder and the accumulator, smaller and/or weaker and/or faster and/or can have an additional hydraulic drive, for example. This additional hydraulic drive preferably has a reset chamber in the cylinder, which is separated from the press chamber by a piston, for example, which is guided in the cylinder and coupled to the ram, and is disconnected from the tank and connected to the accumulator in the reset phase.

It can be provided that in the charging phase, the chamber is closed and/or is disconnected from the accumulator and a tank.

In this way, the ram can be kept at the third stroke height.

It can be provided that in the reset phase, the movement of the ram is performed in that a reset chamber forming the chamber is disconnected from a tank and is connected to the accumulator.

It can then be provided that in the working phase, the reset chamber is disconnected from the accumulator and is connected to the tank.

The ram can then be actively raised or moved further in the closing direction by a press drive. This press drive can be, for example, in comparison to the hydraulic drive formed by reset chamber and accumulator, larger and/or stronger and/or slower and/or can have an additional hydraulic drive, for example. This additional hydraulic drive preferably has a press chamber in the cylinder, which is separated from the reset chamber by a piston, which is guided in the cylinder and coupled to the ram, for example, and in the working phase is disconnected from the tank and is connected to the accumulator.

In the case of each proposed method, the charging volume stream can be set as needed in an arbitrary manner to zero, in particular for or during the regulation of the accumulator pressure p_{S}. Thus, for example, it can be provided that the tank is connected to the pressure fitting, and the charging volume stream is set to zero, in particular for or during the regulation of the accumulator pressure p_{S}, in that a pressure fitting of the pump is connected to a tank. Alternatively or additionally, it can be provided that the charging volume stream is set to zero, in particular for or during the regulation of the accumulator pressure p_{S}, in that the speed of the motor is set to zero.

An excessively rapid rise of the accumulator pressure p_{S} can be decelerated or even ended by the setting to zero.

In the first variant, the setting to zero can be performed rapidly.

In the second variant, the setting to zero can be performed in an energy-saving manner.

It can be provided that:
in each cycle, a charging duration T_{L} is ascertained, during which the charging volume stream is greater than zero;
the charging duration T_{L} is regulated to a charging duration target value T_{SOLL}, in that the speed is set and/or changed accordingly.

In this way, the most uniform possible running of the motor and the pump can be achieved, during which speed peaks are avoided, if the charging duration target value T_{SOLL} is located as much as possible at or just below the cycle duration T_{Z}.

The charging duration target value T_{SOLL} can be selected arbitrarily as needed, for example, such that it is less by a specific percentage than the cycle duration T_{Z}. This percentage is, for example, at least 2% or at least 3% or at least 4% or at least 5% or at least 6% or at least 7% or at least 8% or at least 9% or at least 10% or at least 12% or at least 14% or at least 16% or at least 18% or at least 20%. Alternatively or additionally, this percentage is, for example, at most 2% or at most 3% or at most 4% or at most 5% or at most 6% or at most 7% or at most 8% or at most 9% or at most 10% or at most 12% or at most 14% or at most 16% or at most 18% or at most 20%.

It can be provided that:
in a specific cycle, a cycle duration T_{Z} and a charging duration T_{L}, during which the charging volume stream is greater than zero, and a charging speed n_{L}, which is averaged over the charging duration T_{L}, are ascertained;
for at least one following cycle, the speed is set to an intermediate value n_{Z}, for which n_{Z}=n_{L}·T_{L}: T_{Z}+K_{N}, wherein K_{N} is a speed correction value with 0≦K_{N}<n_{L}·(1-T_{L}:T_{Z}).

In this way, the most uniform possible running of the motor and the pump, during which speed peaks are avoided, can be achieved. The speed correction value K_{N} is used, if 0≦K_{N} applies, as a safety cushion, so that in the following cycle, a pressure and volume reserve can be built up in the accumulator. For example, if in one cycle T_{L}: T_{Z}=75% and n_{L}=1600 RPM were ascertained, accordingly, 0≦K_{N}<1600 RPM·(1-75%)=400 RPM should apply. Therefore, for the following cycle, the third correction value K_{N} can accordingly be, for example, 0 RPM or 50 RPM or 100 RPM or 150 RPM or 200 RPM or 250 RPM or 300 RPM or 350 RPM and the intermediate value n_{Z} can accordingly be 1200 RPM or 1250 RPM or 1300 RPM or 1350 RPM or 1400 RPM or 1450 RPM or 1500 RPM or 1550 RPM.

It can then be provided that in the specific cycle:
firstly the speed is set to the nominal speed n_{N} and
the accumulator pressure p_{S} is then regulated, in particular exclusively, in that the charging volume stream is set to zero and the speed is set to the nominal speed n_{N}.

This is preferably performed after the startup of the press, wherein the specific cycle is in particular the first cycle after the startup of the press.

In this specific cycle, in particular the first cycle, the charging speed n_{L} averaged over the charging duration T_{L} will thus correspond to the nominal speed n_{N}.

It can be provided that the charging volume stream is set and/or changed by the regulation of the accumulator pressure p_{S} such that, in particular in each phase or during the entire cycle, the accumulator pressure p_{S} does not fall below a lower operating pressure p_{U} and/or does not exceed an upper operating pressure p_{O}.

Maintaining the lower operating pressure p_{U} can prevent, for example, in the case of an accumulator which has a gas is a compression medium, this gas from entering the hydraulic circuit. The upper operating pressure p_{O} can be the maximum pressure, for example, that the accumulator can withstand for a longer time without damage or for which the design of the accumulator is intended.

It can then be provided that p_{U}≦P_{SOLL}≦p_{O} applies.

It can be provided that:
at least one of the pressure reference variables P_{SOLL} and/or at least one of the intermediate values n_{Z} and/or at least one of the charging duration target values T_{SOLL} and/or at least one of the correction values K_{P}, K_{N} is stored;
the stored values are used as starting values during a later shaping task for identical or similar workpieces.

Therefore, during a later shaping task, the method can be carried out already with at least partially optimized values.

It can be provided that the accumulator pressure p_{S} is set by means of adaptive regulation.

It can then be provided that during the adaptive regulation, at least one of the pressure reference variables P_{SOLL} and/or at least one of the intermediate values n_{Z} and/or at least one of the charging duration target values T_{SOLL} and/or at least one of the correction values K_{P}, K_{N} is changed.

In each proposed method, each disconnection, for example, the disconnection of the press chamber or the reset chamber from the tank or from the accumulator, and/or each connection, for example, the connection of the press chamber or the reset chamber to the accumulator or to the tank or the connection of the pressure fitting to the accumulator or to the tank, and/or each closing, for example, the closing of the press chamber or the reset chamber, can be performed with the aid of valves, for example. Preferably, at least one valve can be provided or seated between the accumulator and the press chamber and/or at least one valve can be provided or seated between the accumulator and the reset chamber and/or at least one valve can be provided or seated between the accumulator and the pressure fitting and/or at least one valve can be provided or seated between the tank and the press chamber and/or at least one valve can be provided or seated between the tank and the reset chamber and/or at least one valve can be provided or seated between the tank and the pressure fitting.

Each valve can be implemented as needed in an arbitrary manner, for example, as a proportional valve or regulating valve or slope valve or directional valve or check valve or pressure limiting valve.

Each proposed method can be implemented as needed in an arbitrary manner and can have at least one additional phase, for example.

Each press used in one of the proposed methods can be implemented as needed in an arbitrary manner and can have, for example, at least one additional hydraulic cylinder and/or at least one additional ram and/or at least one additional hydraulic pump and/or at least one additional motor and/or at least one additional hydraulic accumulator and/or at least one additional tank for hydraulic fluid. Each cylinder provided in this press can be implemented as needed in an arbitrary manner and can have, for example, at least one additional press chamber and/or at least one additional reset chamber. Each pump provided in this press can be implemented as needed in an arbitrary manner and can have, for example, at least one additional pressure fitting.

The proposed methods can be combined as needed in an arbitrary manner, in particular entirely or partially.

According to a second aspect, the invention proposes a hydraulic press, in particular for shaping workpieces, having:
a hydraulic cylinder, which has at least one chamber,
a ram, which is coupled to the cylinder and on which a shaping tool for shaping a workpiece can be coupled;
a hydraulic pump, which has a pressure fitting,
a motor, which is coupled to the pump and has a nominal speed n_{N},
a hydraulic accumulator, which is connected to at least one of the chambers and the pressure fitting,
a tank for hydraulic fluid, which is connected to at least one of the chambers,
an accumulator pressure sensor for registering the accumulator pressure p_{S} prevailing in the accumulator;
a control unit, which enables an operation of the press in cycles and is connected to the accumulator pressure sensor and the motor;
   wherein:
the motor is implemented such that its speed can be set to the nominal speed n_{N} and to at least one intermediate value n_{Z}, for which 0<n_{Z}<n_{N} applies;
the control unit is implemented such that:
   in at least one phase of each cycle, hydraulic fluid is pressed out of the accumulator into at least one of the chambers by the accumulator pressure p_{S}, to move the ram in relation to the cylinder;
   in at least one part of each cycle, the pump conveys hydraulic fluid into the accumulator with a charging volume stream and the control unit regulates the accumulator pressure p_{S} to a pressure reference variable P_{SOLL}, in that it sets the speed of the motor to the nominal speed n_{N} and to at least one of the intermediate values n_{Z}.

The proposed press can be implemented as needed in an arbitrary manner and can have, for example, the regulation of the accumulator pressure p_{S} in at least one additional phase.

The proposed press enables the execution of the methods proposed according to the first aspect.

It can be provided that the press additionally has:
at least one chamber pressure sensor for registering the chamber pressure p_{K} prevailing in one of the chambers;
   wherein:
the control unit is connected to each chamber pressure sensor;
the control unit is implemented such that in at least one of the phases:
   it selects the pressure reference variable P_{SOLL} as a function in dependence on at least one of the chamber pressures p_{K}.

It can then be provided that for the function P_{SOLL}=p_{K}+K_{P} applies, wherein K_{P} is a pressure correction value with 0<K_{P}.

It can be provided that the control unit is implemented such that the regulation of the accumulator pressure p_{S} occurs in at least one of the phases.

It can be provided that:
each cycle has a closing phase for closing the press, a working phase for shaping the workpiece, a reset phase for opening the press, and a charging phase for removing a shaped workpiece from the press and for inserting a workpiece to be shaped into the press in this sequence;
the control unit is implemented such that it:
   in the closing phase, it moves the ram to a first stroke height, so that the shaping tool touches the workpiece to be shaped or is located at a slight spacing to the workpiece to be shaped;
   in the working phase, it moves the ram further to a second stroke height, so that the shaping tool presses against the workpiece;
   in the reset phase, it moves the ram back to the first stroke height and further to a third stroke height, so that the shaping tool disengages and moves away from the shaped workpiece;
   in the charging phase, it keeps the ram at the third stroke height.

It can then be provided that the control unit is implemented such that, in the closing phase, it disconnects at least one of the chambers from the accumulator and connects it to the tank or disconnects at least one of the chambers from the tank and connects it to the accumulator.

It can be provided that the control unit is implemented such that it causes the movement of the ram in the working phase, in that it disconnects a press chamber, which forms the chamber, from the tank and connects it to the accumulator.

It can then be provided that the control unit is implemented such that, in the reset phase, it disconnects the press chamber from the accumulator and connects it to the tank.

It can be provided that the control unit is implemented such that, in the charging phase, it closes at least one of the chambers and/or disconnects it from the accumulator and tank.

It can be provided that the control unit is implemented such that, in the reset phase, it causes the movement of the ram in that it disconnects a reset chamber, which forms the chamber, from the tank and connects it to the accumulator.

It can then be provided that the control unit is implemented such that, in the working phase, it disconnects the reset chamber from the accumulator and connects it to the tank.

In the case of each proposed press, the charging volume stream can be set as needed in an arbitrary manner to zero, in particular for or during the regulation of the accumulator pressure p_{S}. Thus, for example, it can be provided that the tank is connected to the pressure fitting, and the control unit is implemented such that it sets the charging volume stream to zero in that it connects the pressure fitting to the tank. Alternatively or additionally, it can be provided that the motor is implemented such that its speed can be set to zero, and the control unit is implemented such that it sets the charging volume stream to zero, in that it sets the speed to zero.

It can be provided that the control unit is implemented such that:
in each cycle, it ascertains a charging duration T_{L}, during which the charging volume stream is greater than zero;
it regulates the charging duration T_{L} to a charging duration target value T_{SOLL}, in that it sets and/or changes the speed accordingly.

It can be provided that the control unit is implemented such that:
in a specific cycle, it ascertains a cycle duration T_{Z} and a charging duration T_{L}, during which the charging volume stream is greater than zero, and a charging speed n_{L}, which is averaged over the charging duration T_{L};
for at least one following cycle, it sets the speed to an intermediate value n_{Z}, for which n_{Z}=n_{L}·T_{L}: T_{Z}+K_{N}, wherein K_{N} is a speed correction value with 0≦K_{N}<n_{L}·(1−T_{L}: T_{Z}).

It can then be provided that the control unit is implemented such that, in the specific cycle:
it firstly sets the speed to the nominal speed n_{N} and
it then regulates the accumulator pressure p_{S}, in particular exclusively, in that it sets the charging volume speed to zero and sets the speed to the nominal speed n_{N}.

It can be provided that the control unit is implemented such that it sets and/or changes the charging volume stream by way of the regulation of the accumulator pressure p_{S} such that the accumulator pressure p_{S} does not fall below a lower operating pressure p_{U} and/or does not exceed an upper operating pressure p_{O}.

It can then be provided that p_{U}≦P_{SOLL}≦p_{O} applies.

It can be provided that the control unit is implemented such that:

it stores at least one of the pressure reference variables P_{SOLL} and/or at least one of the intermediate values n_{Z} and/or at least one of the charging duration target values T_{SOLL} and/or at least one of the correction values K_{P}, K_{N}; it uses the stored values as starting values during a later shaping task for identical or similar workpieces.

It can be provided that the control unit is implemented such that it sets or can set the accumulator pressure p_{S} by means of adaptive regulation.

They can then be provided that the control unit is implemented such that in the case of the adaptive regulation, it changes or can change at least one of the pressure reference variables P_{SOLL} and/or at least one of the intermediate values n_{Z} and/or at least one of the charging duration target values T_{SOLL} and/or at least one of the correction values K_{P}, K_{N}.

It can be provided that it additionally has:
at least one valve between the accumulator and the press chamber and/or
at least one valve between the accumulator and the reset chamber and/or
at least one valve between the accumulator and the pressure fitting and/or
at least one valve between the tank and the press chamber and/or
at least one valve between the tank and the reset chamber and/or
at least one valve between the tank and the pressure fitting;
   wherein:
the control unit is connected to the valves.

With the aid of these valves, the control unit can, for example, cause or carry out the disconnection of the press chamber from the tank or from the accumulator and/or the connection of the press chamber or the reset chamber to the accumulator or to the tank or the connection of the pressure fitting to the accumulator or to the tank and/or the closing of the press chamber or the reset chamber.

Each valve can be implemented as needed in an arbitrary manner, for example, as a proportional valve or regulating valve or slope valve or directional valve or check valve or pressure limiting valve.

Each proposed press can be implemented as needed in an arbitrary manner and can have, for example, at least one additional hydraulic cylinder and/or at least one additional ram and/or at least one additional hydraulic pump and/or at least one additional motor and/or at least one additional hydraulic accumulator and/or at least one additional tank for hydraulic fluid and/or at least one additional control unit and/or at least one additional pressure sensor. Each cylinder can be implemented as needed in an arbitrary manner and can have, for example, at least one additional press chamber and/or at least one additional reset chamber. Each pump can be implemented as needed in an arbitrary manner and can have, for example, at least one additional pressure fitting.

The statements on one aspect of the invention, in particular on individual features of this aspect, also similarly apply accordingly for the other aspects of the invention, in particular for corresponding individual features of this aspect.

Embodiments and exemplary embodiments of the invention are explained in greater detail hereafter on the basis of the appended drawings. The individual features resulting therefrom are not restricted to the individual embodiments an exemplary embodiments, however, but rather can be combined with further above-described individual features and/or with individual features of other embodiments and exemplary embodiments. The details in the drawings are only to be interpreted as explanatory, but not as restrictive. The reference signs contained in the claims are not to restrict the scope of protection of the invention in any manner, but rather merely refer to the embodiments shown in the drawings. In the figures of the drawings:

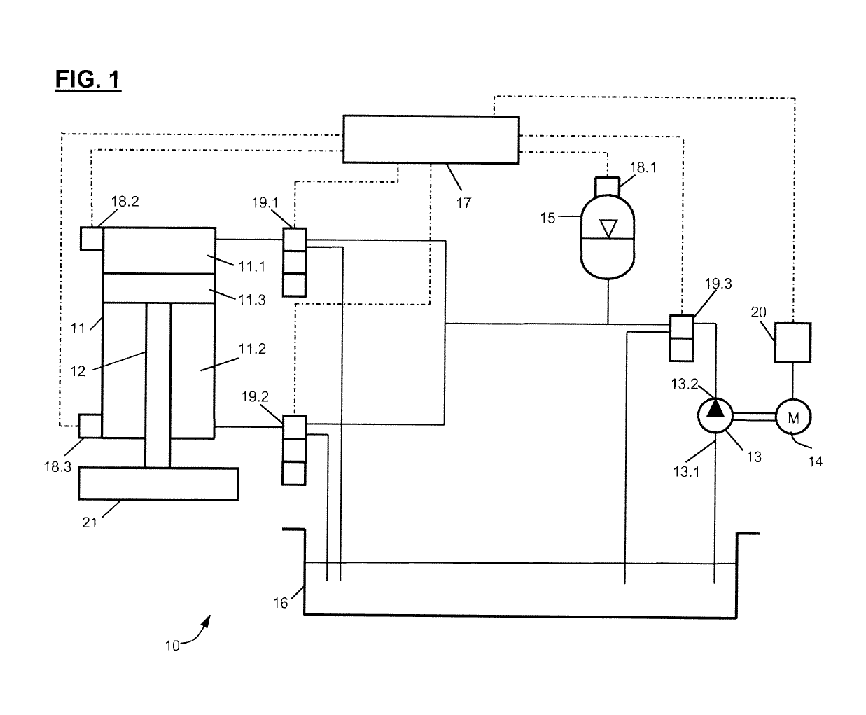

FIG. 1 shows an overview plan of a preferred embodiment of a hydraulic press, wherein the press is located in a state according to a closing phase of a cycle of a preferred embodiment of a method for operating the press;

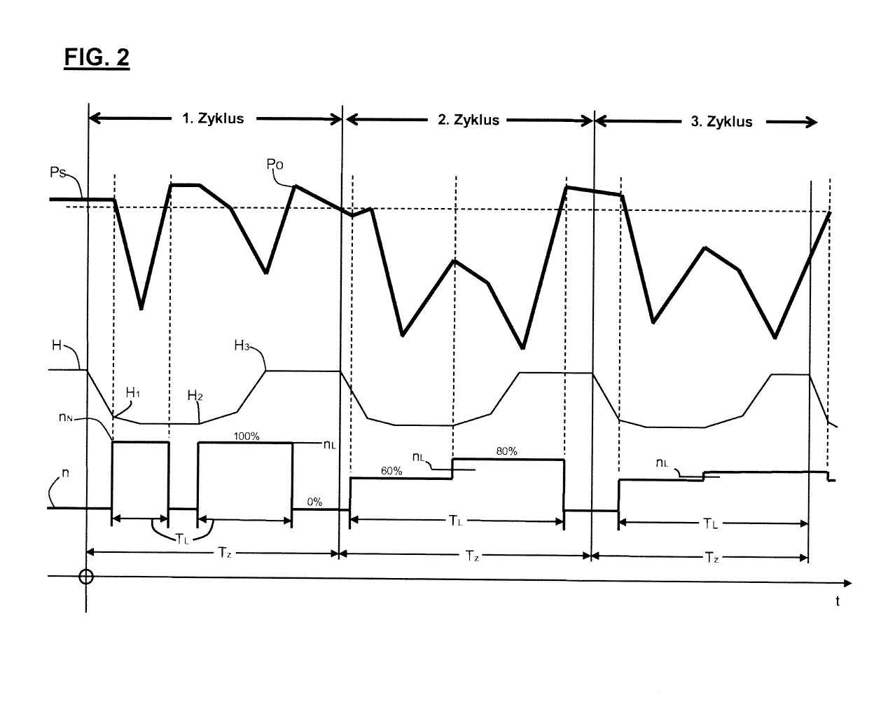

FIG. 2 shows a graph of the time curve of the accumulator pressure in the accumulator of the press of FIG. 1, the travel of the ram of the press, and the speed of the motor of the press over three cycles of the method.

FIG. 1 schematically shows a preferred embodiment of a hydraulic press 10, which can be operated in cycles, each one of which has a closing phase, a working phase, a reset phase, and a charging phase in this sequence. The press 10 has a hydraulic cylinder 11, a ram 12, a charging pressure pump or hydraulic pump 13, a motor 14, a hydraulic accumulator 15, a pre-filling container or tank 16 for hydraulic fluid, a control unit 17, three pressure sensors 18.1 to 18.3, three valves 19.1 to 19.3, and a frequency converter 20.

The cylinder 11 has two chambers, namely a press chamber 11.1 and a reset chamber 11.2, and a piston 11.3, which is guided in the cylinder 11 and which separates a press chamber 11.1, which borders its upper side, from a reset chamber 11.2, which borders its lower side. The ram 12 is fastened with its upper end on the lower side of the piston 11.3 and is therefore coupled to the cylinder 11 and holds on its lower end a shaping tool 21, which is coupled thereto, for shaping a workpiece. The pump 13 has a suction fitting 13.1 and a pressure fitting 13.2. The motor 14 is coupled as a drive to the pump 15. The accumulator 15 is connected to the press chamber 11.1, the reset chamber 11.2, and the pressure fitting 13.2 and is implemented, for example, as a hydraulic accumulator having a pressure container filled with nitrogen. The tank 16 is connected to the press chamber 11.1, the reset chamber 11.2, and the suction fitting 13.1.

The motor 14 is an asynchronous motor, for example, and has a nominal speed n_{N}, which is 2000 RPM, for example. The frequency converter 20 is connected, on the one hand, to the motor 14 and, on the other hand, to the control unit 17. The control unit 17 is implemented such that it can set the speed of the motor 14, by suitable activation of the frequency converter 20, continuously or nearly continuously from zero up to the nominal speed n_{N}, and therefore to zero, to the nominal speed n_{N}, and to at least one intermediate value n_{Z}, for which 0<n_{Z}<n_{N}.

The control unit 17 is additionally connected to the pressure sensors 18, of which an accumulator pressure sensor 18.1 is used for registering the accumulator pressure p_{S} prevailing in the accumulator 15, a first chamber pressure sensor 18.2 is used for registering the working pressure p_{A} prevailing in the press chamber 11.1, and a second chamber pressure sensor 18.3 is used for registering the reset pressure p_{R} prevailing in the reset chamber 11.2.

The control unit 17 is additionally connected to the valves 19, which are directional valves, for example, and of which a first valve 19.1 is seated between the press chamber 11.1 and the accumulator 15 and between the press chamber 11.1 and the tank 16, a second valve 19.2 is seated between the reset chamber 11.2 and the accumulator 15 and between the reset chamber 11.2 and the tank 16, and a third valve 19.3 is seated between the pressure fitting 13.2 and the accumulator 15 and the pressure fitting 13.2 and the tank 16. The first valve 19.1 is a 3/3 directional valve, i.e., it has three fittings for hydraulic fluid lines and three switch positions, and can alternately disconnect the press chamber 11.1 from the tank 16 and connect it to the accumulator 15 or disconnect it from the accumulator 15 and connect it to the tank 16 or disconnect it from the accumulator 15 and the tank 16. The second valve 19.2 is a 3/3 directional valve and can alternately disconnect the reset chamber 11.2 from the tank 16 and connect it to the accumulator 15 or disconnect it from the accumulator 15 and connect it to the tank 16 or disconnect it from the accumulator 15 and the tank 16. The third valve 19.3 is a 3/2 directional valve, i.e., it has three fittings for hydraulic fluid lines and two switch positions, and can alternately disconnect the pressure fitting 13.2 from the tank 16 and connect it to the accumulator 15 or disconnect it from the accumulator 15 and connect it to the tank 16.

FIG. 2 schematically shows three cycles of a preferred embodiment of a method for operating the press 10 of FIG. 1 and for shaping workpieces by means of the press 10 from FIG. 1 on the basis of the accumulator pressure p_{S} in the accumulator 15, the movement H of the ram 12, and the speed n of the motor 14 over time.

The control unit 17 enables a cyclic operation of the press 10 according to this preferred embodiment of the method. It is implemented such that, in each cycle, it lowers the ram 12 and the shaping tool 21 coupled thereto in the closing phase to a first stroke height H1, lowers it in the working phase further to a second stroke height H2 and keeps it there, raises it in the reset phase back beyond the first stroke height H1 and further to a third stroke height H3, and keeps it in the charging phase at the third stroke height H3. In FIG. 2, the closing phase can be recognized at the steeply dropping segment of the H line, the working phase can be recognized at the flatly falling and then horizontal segment adjoining thereon, the reset phase can be recognized at the flat and then steeply rising segment adjoining thereon, and the charging phase can be recognized at the horizontal segment adjoining thereon.

The lowering of the ram 12 and the shaping tool 21 in the closing phase is achieved or caused by the control unit 17 in that, by appropriate activation of the first valve 19.1 and the second valve 19.2, it disconnects the press chamber 11.1 and the reset chamber 11.2 in each case from the accumulator 15 and connects them to the tank 16. Therefore, the piston 11.3, the ram 12, and the shaping tool 21 are drawn downward by their intrinsic weight. In this case, hydraulic oil is suctioned from the tank 16 into the press chamber 11.1 and pressed out of the reset chamber 11.2 into the tank 16.

The lowering of the ram 12 and the shaping tool 21 in the working phase is achieved or caused by the control unit 17 in that, by appropriate activation of the first valve 19.1, it disconnects the press chamber 11.1 from the tank 16 and connects it to the accumulator 15. The accumulator 15 is nearly fully charged after the startup of the press 10 and therefore at the beginning of the first cycle, so that the accumulator pressure p_{S} is just below an upper operating pressure p_{O}, which corresponds to the maximum pressure which the accumulator 15 can withstand for a longer time without damage or for which its design is intended. Therefore, the piston 11.3, the ram 12, and the shaping tool 21 are pressed downward by the hydraulic oil, which is under the accumulator pressure p_{S} in the accumulator 15, against the shaping force or the shaping pressure. In this case, hydraulic oil is pressed out of the accumulator 15 into the press chamber 11.1 and out of the reset chamber 11.2 into the tank 16.

The holding of the ram 12 and the shaping tool 21 in the working phase is achieved or caused by the control unit 17 in that, by appropriate activation of the first valve 19.1, it disconnects the press chamber 11.1 from the accumulator 15 and the tank 16 and thus closes it. Since therefore neither can the hydraulic oil enclosed in the press chamber flow out nor can hydraulic oil flow back into the press chamber 11.1, the piston 11.3, the ram 12, and the shaping tool 21 are kept motionless.

The raising of the ram 12 and the shaping tool 21 in the reset phase is achieved or caused by the control unit 17 in that, by appropriate activation of the first valve 19.1, it disconnects the press chamber 11.1 from the accumulator 15 and connects it to the tank 16 and, by appropriate activation of the second valve 19.2, it disconnects the reset chamber 11.2 from the tank 16 and connects it to the accumulator 15. Therefore, the piston 11.3, the ram 12, and the shaping tool 21 are pressed upward by the hydraulic oil, which is under the accumulator pressure p_{S} in the accumulator 15. In this case, hydraulic oil is pressed out of the accumulator 15 into the reset chamber 11.2 and out of the press chamber 11.1 into the tank 16.

The control unit 17 is additionally implemented such that in all phases, it charges the accumulator 15 in accordance with the demand, i.e., in dependence on the respective presently required working pressure p_{A} and reset pressure p_{R}, using a charging volume stream.

The charging of the accumulator 15 is achieved or caused by the control unit 17, in that, by appropriate activation of the frequency converter 20, it sets the speed of the motor 14 so that it drives the pump 13 and, by appropriate activation of the third valve 19, it disconnects the pressure fitting 13.2 from the tank 16 and connects it to the accumulator 15. Therefore, the pump 13 suctions hydraulic oil out of the tank 16 and presses it into the accumulator 15 using a charging volume stream, which is dependent on the speed of the motor 14 set by means of the frequency converter 20.

In this preferred embodiment, the control unit 17 is additionally implemented such that, in all phases, it regulates the accumulator pressure p_{S} to a pressure reference variable P_{SOLL}, in that it sets the speed and therefore the charging volume stream accordingly, as described in greater detail hereafter.

The setting of the speed for the pressure regulation in accordance with demand is achieved or caused by the control unit 17 in that, by suitable activation of the frequency converter 20, it sets the speed continuously from zero to the nominal speed n_{N} and therefore to zero, to the nominal speed n_{N}, and to intermediate values n_{Z}, for which 0<n_{Z}<n_{N}.

The regulation of the accumulator pressure p_{S} is achieved or caused by the control unit 17 in that, in the first cycle after startup of the press 10 shown in FIG. 2, it firstly sets the speed to the nominal speed n_{N} and then exclusively regulates the accumulator pressure p_{S} in that either it sets the charging volume stream to zero, in that it sets the speed to zero, or it sets the speed to the nominal speed n_{N}, and also ascertains a cycle duration T_{Z} and a charging duration T_{L}, during which the charging volume stream is greater than zero, and also ascertains a charging speed n_{L}, which is averaged over the charging duration T_{L}.

In FIG. 2, the control unit 17 has set for this cycle, for example, the speed n in the closing phase to 0% of the nominal speed n_{N}, in a starting section of the working phase to 100% of the nominal speed n_{N}, in a subsequent end section of the working phase to 20% of the nominal speed n_{N}, in the reset phase and in a starting section of the charging phase to 100% of the nominal speed n_{N}, and then in a subsequent end section of the charging phase to 0% of the nominal speed n_{N}. It has ascertained in this example for the charging duration T_{L} the value 75% of the cycle duration T_{Z} and for the charging speed n_{L}, the value 100% of the nominal speed n_{N}.

In this preferred embodiment, the control unit 17 is additionally implemented such that, for the second cycle shown in FIG. 2, during the regulation, it sets the speed from zero up to a maximum intermediate value n_{Z}, for which n_{Z}=n_{L}·T_{L}: T_{Z}+K_{N} applies, wherein K_{N} is a speed correction value with 0≦K_{N}<n_{L}·(1−T_{L}: T_{Z}). For example, for the speed correction value K_{N}=5%·n_{N} applies. Since the control unit 17 in the first cycle has ascertained T_{L}: T_{Z}=75% and n_{L}=100%·n_{N}=n_{N}, for the second cycle it calculates n_{L}·T_{L}: T_{Z}=n_{N}·75% and n_{Z}=n_{N}·75%+5%·n_{N}=80%·n_{N}.

In this preferred embodiment, the control unit is additionally implemented such that, in the second cycle, similarly to the first cycle, it again ascertains the cycle duration T_{Z}, the charging duration T_{L}, and the charging speed n_{L}.

In FIG. 2, the control unit 17 has set for this cycle, for example, the speed n in a starting section of the closing speed to 0% of the nominal speed n_{N}, in a subsequent end section of the closing phase and the working phase to 60% of the nominal speed n_{N}, in the reset phase and in a starting section of the charging phase to the maximum intermediate value n_{Z}, i.e., 80% of the nominal speed n_{N}, and then in a subsequent end section of the charging phase to 0% of the nominal speed n_{N}. It has ascertained in this example for the cycle duration T_{Z} the same value as in the first cycle, for the charging duration T_{L} a greater value than in the first cycle, and for the charging speed n_{L} a smaller value than in the first cycle.

In this preferred embodiment, the control unit 17 is additionally implemented such that, for the third cycle shown in FIG. 2 and each following cycle, similarly to the first and second partial traction means during the regulation, it sets the speed from zero up to a maximum intermediate value n_{Z}, for which n_{Z}=n_{L}·T_{L}: T_{Z}+K_{N} applies, wherein the cycle duration T_{Z}, the charging duration T_{L}, and the charging speed n_{L} originate from the respective preceding cycle. (1435)

### LIST OF REFERENCE NUMERALS: P1435

10 press
11 cylinder
11.1 press chamber of 11
11.2 reset chamber of 11
11.3 piston of 11
12 ram
13 pump
13.1 suction fitting of 13
13.2 pressure fitting of 13
14 motor
15 accumulator
16 tank
17 control unit
18 pressure sensors
19 valve
20 frequency converter
21 shaping tool

1. A method for operating a hydraulic press in cycles comprising:
operating each cycle with at least one phase, in which hydraulic fluid is pressed out of a hydraulic accumulator into a chamber of a hydraulic cylinder of the press by an accumulator pressure p_{S} prevailing in the accumulator, in order to move a ram of the press, which is coupled to the cylinder, and which can be coupled to a shaping tool for shaping a workpiece, in relation to the cylinder;
wherein in at least one part of each cycle, a hydraulic pump driven by a motor conveys the hydraulic fluid into the accumulator with a charging volume stream and the accumulator pressure p_{S} is regulated to a pressure reference variable P_{SOLL}, in that a speed of the motor is set to a nominal speed n_{N} of the motor and to at least one intermediate value n_{Z}, for which 0<n_{Z}<n_{N} applies.

2. The method according to claim 1, wherein in at least one of the phases:
the pressure reference variable P_{SOLL} is selected as a function in dependence on at least one chamber pressure p_{K} prevailing in the chamber.

3. The method according to claim 2, wherein:
the function P_{SOLL}=p_{K}+K_{P} applies, wherein K_{P} is a pressure correction value with 0<K_{P}.

4. The method according to claim 1, wherein:
regulation of the accumulator pressure p_{S} is performed in at least one of the phases.

5. The method according to claim 1, wherein:
each cycle has a closing phase for closing the press, a working phase for shaping the workpiece, a reset phase for opening the press, and a charging phase for removing a shaped workpiece from the press and for inserting a workpiece to be shaped into the press in this sequence;
wherein in the closing phase, the ram is moved to a first stroke height, so that the shaping tool touches the workpiece to be shaped or is located at a slight spacing to the workpiece to be shaped;
wherein in the working phase, the ram is moved further to a second stroke height, so that the shaping tool presses against the workpiece to be shaped;
wherein in the reset phase, the ram is moved back to the first stroke height and further to a third stroke height, so that the shaping tool disengages and moves away from the shaped workpiece;
wherein in the charging phase, the ram is kept at the third stroke height.

6. The method according to claim 5, wherein in the closing phase:
the chamber is disconnected from the accumulator and connected to a tank; or
the chamber is disconnected from the tank and connected to the accumulator.

7. The method according to claim 5, wherein in the working phase:
movement of the ram is performed in that a press chamber which forms the chamber is disconnected from a tank and connected to the accumulator.

8. The method according to claim 7, wherein in the reset phase:
the press chamber is disconnected from the accumulator and connected to the tank.

9. The method according to claim 5, wherein in the charging phase:
the chamber is closed, disconnected, or closed and disconnected from the accumulator and a tank.

10. The method according to claim 5, wherein in the reset phase:
movement of the ram is performed in that a reset chamber, which forms the chamber, is disconnected from a tank and connected to the accumulator.

11. The method according to claim 10, wherein in the working phase:
the reset chamber is disconnected from the accumulator and connected to the tank.

12. The method according to claim 10, wherein:
the tank is connected to a pressure fitting;
the charging volume stream is set to zero in that the pressure fitting of the pump is connected to the tank.

13. The method according to claim 10, wherein:
the charging volume stream is set to zero in that the speed of the motor is set to zero.

14. The method according to claim 10, wherein:
in each cycle, a charging duration T_{L} is ascertained, during which the charging volume stream is greater than zero;
the charging duration T_{L} is regulated to a charging duration target value T_{SOLL}, in that the speed of the motor is set.

15. The method according to claim 10, wherein:
in a specific cycle, a cycle duration T_{Z} and a charging duration T_{L}, during which the charging volume stream is greater than zero, and a charging speed n_{L}, which is averaged over the charging duration T_{L}, are ascertained;
for at least one following cycle, the speed of the motor is set to an intermediate value n_{Z}, for which n_{Z}=n_{L}:T_{Z}+K_{N} applies, wherein K_{N} is a speed correction value with 0≦K_{N}<n_{L}·(1−T_{L}:T_{Z}).

16. The method according to claim 15, wherein in the specific cycle:
firstly the speed of the motor is set to the nominal speed n_{N} and
then the accumulator pressure p_{S} is regulated in that the charging volume stream is set to zero and the speed of the motor is set to the nominal speed n_{N}.

17. The method according to claim 15, wherein:
the charging volume stream is set by regulation of the accumulator pressure p_{S} such that the accumulator pressure p_{S} does not fall below a lower operating pressure p_{U} and does not exceed an upper operating pressure p_{O}.

18. The method according to claim 17, wherein:
P_{U}≦P_{SOLL}≦p_{O} applies.

19. The method according to claim 17, wherein:
at least one value selected from the group consisting of at least one pressure reference variable P_{SOLL}, at least one intermediate value n_{Z}, at least one charging duration target value T_{SOLL}, at least one speed correction value K_{N} and at least one pressure correction value K_{P} is stored as a stored value;
the stored value is used as a starting value during a later shaping task for identical or similar workpieces.

20. The method according to claim 17, wherein:
the accumulator pressure p_{S} is set by adaptive regulation.

21. The method according to claim 20, wherein:
during the adaptive regulation, at least one value selected from the group consisting of at least one pressure reference variable P_{SOLL}, at least one intermediate value n_{Z}, at least one charging duration target value T_{SOLL}, at least one speed correction value K_{N} and at least one pressure correction value K_{P} is changed.

22. A hydraulic press, comprising:
a hydraulic cylinder, which has at least one chamber,
a ram, which is coupled to the cylinder and on which a shaping tool for shaping a workpiece can be coupled;
a hydraulic pump, which has a pressure fitting,
a motor, which is coupled to the pump and has a nominal speed n_{N},
a hydraulic accumulator, which is connected to at least one of the chambers and the pressure fitting,
a tank for hydraulic fluid, which is connected to at least one of the chambers,
an accumulator pressure sensor for registering an accumulator pressure p_{S} prevailing in the accumulator;
a control unit, which enables an operation of the press in cycles and is connected to the accumulator pressure sensor and the motor;
wherein:
the motor is implemented such that its speed can be set to the nominal speed n_{N} and to at least one intermediate value n_{Z}, for which 0<n_{Z}<n_{N} applies;
the control unit is implemented such that:
in at least one phase of each cycle, hydraulic fluid is pressed out of the accumulator into at least one of the chambers by the accumulator pressure p_{S}, to move the ram in relation to the cylinder;
in at least one part of each cycle, the pump conveys hydraulic fluid into the accumulator with a charging volume stream and the control unit regulates the accumulator pressure p_{S} to a pressure reference variable P_{SOLL}, in that it sets the speed of the motor to the nominal speed n_{N} and to at least one of the intermediate values n_{Z}.

23. The press according to claim 22, further comprising:
at least one chamber pressure sensor for registering at least one chamber pressure p_{K} prevailing in one of the chambers;
wherein:
the control unit is connected to each chamber pressure sensor;
the control unit is implemented such that in at least one of the phases:
it selects the pressure reference variable P_{SOLL} as a function in dependence on at least one of the chamber pressures p_{K}.

24. The press according to claim 23, wherein:
the function P_{SOLL}=p_{K}+K_{P} applies, wherein K_{P} is a pressure correction value with 0<K_{P}.

25. The press according claim 22, wherein:
the control unit is implemented such that:
regulation of the accumulator pressure p_{S} is performed in at least one of the phases.

26. The press according to claim 22, wherein:
each cycle has a closing phase for closing the press, a working phase for shaping the workpiece, a reset phase for opening the press, and a charging phase for removing a shaped workpiece from the press and for inserting a workpiece to be shaped into the press in this sequence;
the control unit is implemented such that:
in the closing phase, the control unit moves the ram to a first stroke height, so that the shaping tool touches the workpiece to be shaped or is located at a slight spacing to the workpiece to be shaped;
in the working phase, the control unit moves the ram further to a second stroke height, so that the shaping tool presses against the workpiece;
in the reset phase, the control unit moves the ram back to the first stroke height and further to a third stroke height, so that the shaping tool disengages and moves away from the shaped workpiece;
in the charging phase, the control unit keeps the ram at the third stroke height.

27. The press according to claim 26, wherein:
the control unit is implemented such that, in the closing phase:
the control unit disconnects at least one of the chambers from the accumulator and connects it to the tank; or
the control unit disconnects at least one of the chambers from the tank and connects it to the accumulator.

28. The press according to claim 26, wherein:
the control unit is implemented such that, in the working phase:
the control unit causes movement of the ram in that it disconnects a press chamber forming the chamber from the tank and connects it to the accumulator.

29. The press according to claim 28, wherein:
the control unit is implemented such that, in the reset phase:
the control unit disconnects the press chamber from the accumulator and connects it to the tank.

30. The press according to claim 26, wherein:
the control unit is implemented such that, in the charging phase:
the control unit closes, disconnects, or closes and disconnects the at least one chamber from the accumulator and a tank.

31. The press according to one of claim 26, wherein:
the control unit is implemented such that, in the reset phase:
the control unit causes movement of the ram, in that it disconnects a reset chamber forming the chamber from the tank and connects it to the accumulator.

32. The press according to claim 31, wherein:
the control unit is implemented such that, in the working phase:
the control unit disconnects the reset chamber from the accumulator and connects it to the tank.

33. The press according to claim 31, wherein:
the tank is connected to the pressure fitting;
the control unit is implemented such that:
the control unit sets the charging volume stream to zero in that it connects the pressure fitting to the tank.

34. The press according to claim 31, wherein:
the motor is implemented such that its speed can be set to zero;
the control unit is implemented such that:
the control unit sets the charging volume stream to zero in that it sets the speed of the motor to zero;

35. The press according to claim 31, wherein:
the control unit is implemented such that:
in each cycle, the control unit ascertains a charging duration T_{L}, during which the charging volume stream is greater than zero;
the control unit regulates the charging duration T_{L} to a charging duration target value T_{SOLL}, and sets the speed of the motor accordingly.

36. The press according to claim 31, wherein:
the control unit is implemented such that:
in a specific cycle, the control unit ascertains a cycle duration T_{Z} and a charging duration T_{L}, during which the charging volume stream is greater than zero, and a charging speed n_{L}, which is averaged over the charging duration T_{L};
wherein for at least one following cycle, the control unit sets the speed of the motor to an intermediate value n_{Z}, for which n_{Z}=n_{L}·T_{L}:T_{Z}+K_{N} applies,
wherein K_{N} is a speed correction value with 0≦K_{N}<n_{L}·(1−T_{L}:T_{Z}).

37. The press according to claim 36, wherein:
the control unit is implemented such that, in the specific cycle:
the control unit firstly sets the speed of the motor to the nominal speed n_{N} and
then regulates the accumulator pressure p_{S} exclusively in that it sets the charging volume stream speed to zero and sets the speed of the motor to the nominal speed n_{N}.

38. The press according to claim 36, wherein:
the control unit is implemented such that:
the control unit sets the charging volume stream by way of regulation of the accumulator pressure p_{S} such that the accumulator pressure p_{S} does not fall below a lower operating pressure p_{U} and does not exceed an upper operating pressure p_{O}.

39. The press according to claim 38, wherein:
P_{U}≦P_{SOLL}≦p_{O} applies.

40. The press according to claim 38, wherein:
the control unit is implemented such that:
the control unit stores at least one value selected from the group consisting of at least one pressure reference variable P_{SOLL}, at least one intermediate value n_{Z}, at least one charging duration target value T_{SOLL}, at least one speed correction value K_{N} and at least one pressure correction value K_{P} as a stored value;
the control unit uses the stored value as a starting value during a later shaping task for identical or similar workpieces.

41. The press according to claim 38, wherein:
the control unit is implemented such that:
the control unit sets the accumulator pressure p_{S} by adaptive regulation.

42. The press according to claim 41, wherein:
the control unit is implemented such that:
during the adaptive regulation, the control unit changes at least one value selected from the group consisting of at least one pressure reference variable P_{SOLL}, at least one intermediate value n_{Z}, at least one charging duration target value T_{SOLL}, at least one speed correction value K_{N} and at least one pressure correction value K_{P}.

43. The press according to claim 38, further comprising:
the control unit connected to at least one valve selected from the group consisting of at least one valve between the accumulator and a press chamber, at least one valve between the accumulator and the reset chamber, at least one valve between the accumulator and the pressure fitting, at least one valve between the tank and the press chamber, at least one valve between the tank and the reset chamber and at least one valve between the tank and the pressure fitting.
